(19) United States
(12) Patent Application Publication
(10) Pub. No.: US 2024/0012555 A1
(43) Pub. Date: Jan. 11, 2024

(54) IDENTIFYING AND NAVIGATING TO A VISUAL ITEM ON A WEB PAGE

(71) Applicant: Google LLC, Mountain View, CA (US)

(72) Inventors: Hannah Van Opstal, Waterloo (CA); David Bokan, Toronto (CA); Ian Vollick, Waterloo (CA); Eugene Girard, Kitchener (CA)

(21) Appl. No.: 17/814,927

(22) Filed: Jul. 26, 2022

Related U.S. Application Data
(60) Provisional application No. 63/367,863, filed on Jul. 7, 2022.

(51) Int. Cl. G06F 3/04855; G06F 3/0482; G06F 40/143

(52) U.S. Cl. CPC G06F 3/04855; G06F 3/0482; G06F 40/143

(57) ABSTRACT

According to an aspect, a method includes receiving a resource locator of a web page and obtaining a visual item specifier, where the visual item specifier includes information associated with a visual item on the web page. The method includes identifying, using the visual item specifier, a location of the visual item on the web page, rendering at least a portion of the web page on a user interface of an application, and rendering a visual indicator on the user interface. The visual indicator is rendered in an area of the user interface that is different from the location of the visual item on the web page. The visual indicator is configured to indicate a presence of the visual item on the web page.

### CROSS-REFERENCE TO RELATED APPLICATION

This application claims priority to U.S. Provisional Application No. 63/367,863, filed on Jul. 7, 2022, entitled “IDENTIFYING AND NAVIGATING TO A VISUAL ITEM ON A WEB PAGE”, the disclosure of which is incorporated herein by reference in its entirety.

### BACKGROUND

A user may be interested in viewing a particular visual item (e.g., an image, video, text, etc.) on a web page. However, the location of the visual item on the web page is dependent on the developer's preference, which may be at the bottom of the web page, in the middle of the web page, etc., and may not be readily visible.

### SUMMARY

This disclosure relates to a browser engine configured to render a visual indicator when at least a portion of the web page is rendered, where the visual indicator indicates a presence and/or a location of a visual item (e.g., an image, video, or text) on the web page. When the visual indicator is selected, the browser engine may scroll the web page such that the visual item is visible to the user. In some examples, the browser engine highlights the visual item on the web page. For example, the browser engine may add or modify a display characteristic of the visual item or the web page, which may include enlarging a border of the visual item, changing a color of the border, changing the appearance of the visual item, or changing the appearance of the web page in a manner that highlights the visual item, etc.

In some aspects, the techniques described herein relate to a method including receiving a resource locator of a web page, obtaining a visual item specifier, the visual item specifier including information associated with a visual item on the web page, identifying, using the visual item specifier, a location of the visual item on the web page, rendering at least a portion of the web page on a user interface of an application, and rendering a visual indicator on the user interface, the visual indicator rendered in an area of the user interface that is separate (e.g., different) from the location of the visual item on the web page, the visual indicator configured to indicate a presence of the visual item on the web page.

In some aspects, the techniques described herein relate to an apparatus including at least one processor, and a non-transitory computer-readable medium including executable instructions that causes the at least one processor to receive a resource locator of a web page, obtain a visual item specifier, the visual item specifier including information associated with a visual item on the web page, identify, using the visual item specifier, a location of the visual item on the web page, render at least a portion of the web page on a user interface of an application, and render a visual indicator on the user interface, the visual indicator rendered in an area of the user interface that is separate (e.g., different) from the location of the visual item on the web page, the visual indicator configured to indicate a presence of the visual item on the web page.

In some aspects, the techniques described herein relate to a non-transitory computer-readable medium storing executable instructions that cause at least one processor to execute operations, the operations including receiving a resource locator of a web page, obtaining a visual item specifier, the visual item specifier including information associated with a visual item on the web page, identifying, using the visual item specifier, a location of the visual item on the web page, rendering at least a portion of the web page on a user interface of an application, and rendering a visual indicator on the user interface, the visual indicator rendered in an area of the user interface that is separate (e.g., different) from the location of the visual item on the web page, the visual indicator configured to indicate a presence of the visual item on the web page.

The details of one or more implementations are set forth in the accompanying drawings and the description below. Other features will be apparent from the description and drawings, and from the claims.

### BRIEF DESCRIPTION OF THE DRAWINGS

FIG. 1A illustrates a system for rendering a visual indicator that indicates a presence and/or a location of a visual item on a web page according to an aspect.

FIG. 1B illustrates a visual indicator being displayed in a viewport while the visual item is outside the viewport according to an aspect.

FIG. 1C illustrates the visual item being displayed in the viewport in response to selection of the visual indicator according to an aspect.

FIG. 1D illustrates an example of a resource locator having a visual item specifier according to an aspect.

FIG. 1E illustrates an example of a visual item specifier being separate from the resource locator according to an aspect.

FIG. 1F illustrates an example of a browser engine according to an aspect.

FIG. 2A illustrates a user interface for receiving a visual item query and displaying search results that correspond to the visual item query according to an aspect.

FIG. 2B illustrates an example of a user interface for displaying a web page corresponding to one of the search results and a visual indicator that indicates a presence of a visual item on the web page according to an aspect.

FIG. 3A illustrates an example of a user interface for displaying a collection of visual items according to an aspect.

FIG. 3B illustrates an example of a user interface for displaying a web page that corresponds to one of the visual items in FIG. 3A and a visual indicator that indicates a presence of a visual item on the web page according to an aspect.

FIG. 4 illustrates a user interface depicting a user control to create a resource locator that can identify a visual item on a web page according to an aspect.

FIGS. 5A and 5B illustrate a user interface having a highlight indicator that highlights a visual item according to an aspect.

FIGS. 6A and 6B illustrate a user interface having a visual indicator configured as an element on a navigation scroll bar according to an aspect.

FIGS. 7A and 7B illustrate a user interface having a visual indicator configured as a user interface (UI) object according to an aspect.

FIGS. 8A and 8B illustrate a user interface having a visual indicator configured as a UI object according to another aspect.

FIG. 9 illustrates a user interface with an annotation section that highlights a visual item according to an aspect.

FIGS. 10A through 10C illustrate an example of an interstitial web page that is displayed before a target page according to an aspect.

FIGS. 11A through 11C illustrate an example of highlighting an image using an animation effect according to an aspect.

FIG. 12 is a flowchart depicting example operations of rending a visual indicator to indicate a presence of a visual item on a web page according to an aspect.

FIG. 13 shows an example of a computer device and a mobile computer device according to an aspect.

### DETAILED DESCRIPTION

This disclosure relates to a browser engine for rendering a visual indicator on a display of a computing device when a web page is loaded, where the visual indicator indicates a presence and/or location of a visual item (e.g., an image, a video, text, etc.) on the web page. A user may be interested in viewing a particular visual item on the web page. For example, a user may select a particular visual item from search results or the user may select a particular visual item from a website that has a collection of visual items. In some examples, a user may select a particular visual item on a web page to generate a link (e.g., a resource locator) that can also identify the visual item and the user can share that link with other users.

When the web page is loaded, the visual item may not be visible and the user may have to navigate (e.g., scroll) the web page to locate the visual item on the web page. For example, the visual item may be located towards the bottom of the web page, therefore, when the web page is loaded, the visual item may be outside a viewport. Furthermore, an application may not have the ability to search for and/or provide a user a control for searching for images and/or videos on a loaded web page. However, according to the techniques discussed herein, the browser engine provides a technical solution of rendering a visual indicator when at least a portion of the web page is rendered, where the visual indicator may assist the user in locating a visual item on the web page.

The visual indicator is displayed in an area (e.g., location) that is separate (e.g., different) from the location of the visual item. In some examples, the visual indicator is a user interface (UI) element or object, which can identify a presence or location of the visual item. In some examples, the visual indicator includes an image representation (e.g., a thumbnail) of the visual item. In some examples, the visual indicator includes a graphical feature (e.g., an arrow representation) that points to where the visual item is located on the web page. In some examples, the visual indicator is a highlighted portion on a navigation scroll element. In some examples, the visual indicator is selectable or includes one or more selectable controls that cause the browser engine to navigate to the visual item (and, in some examples, other visual items). In some examples, the visual indicator is an animation effect.

In some examples, when the visual indicator is selected by the user (or a control on the visual indicator is selected by the user), the browser engine may scroll the web page such that the visual item is positioned in the application's viewport (e.g., the web page is moved so that the visual item is visible to the user). In some examples, the browser engine is configured to also highlight the visual item, e.g., add or modify a display characteristic of the visual item or the web page, which may include enlarging a border of the visual item, changing a color of the border, changing the appearance of the visual item, or changing the appearance of the web page in a manner that highlights the visual item, etc.

The browser engine may receive a resource locator that identifies a web page to be rendered on a display of a computing device. The resource locator includes an address of the web page on a server computer, and the browser engine uses the address to retrieve the web page. The browser engine obtains a visual item specifier associated with the web page, where the visual item specifier identifies a visual item that is included on the web page. In some examples, the visual item specifier is included as part of the resource locator. In some examples, the visual item specifier is separate from the resource locator and the resource locator is obtained from an underlying application or another application.

The browser engine may use the visual item specifier to identify a location of the visual item on the web page. The visual item specifier includes metadata about an attribute of the visual item. The attribute may define a property that can be set to different values, and the metadata may be the value(s) of that property. In some examples, an attribute of a visual item may be a path or link (e.g., URL link) (e.g., “hill2.web”) of where the visual item is stored. The metadata may be one or more values of the link (e.g., at least a portion of the link). In some examples, the visual item specifier includes a cascading style sheets (CSS) selector or a CSS selector directive. The browser engine uses the metadata to search visual item tags (e.g., image tags, video tags, etc.) in the source code of the web page to identify the visual item and determine the location of the visual item on the web page. Then, the browser engine may render a visual indicator on the display that indicates the presence and/or the location of the visual item. These and other features are further described with reference to the figures.

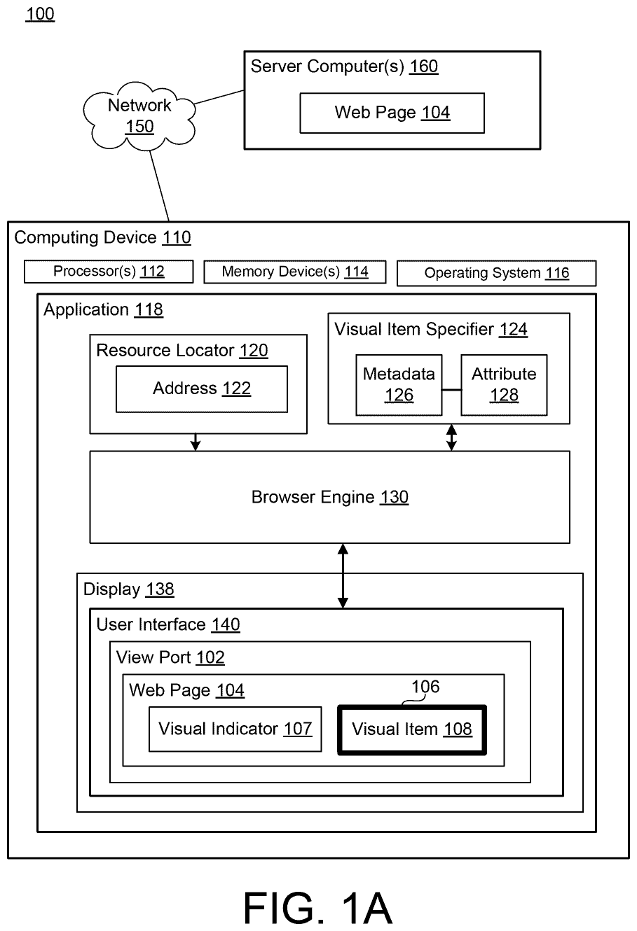

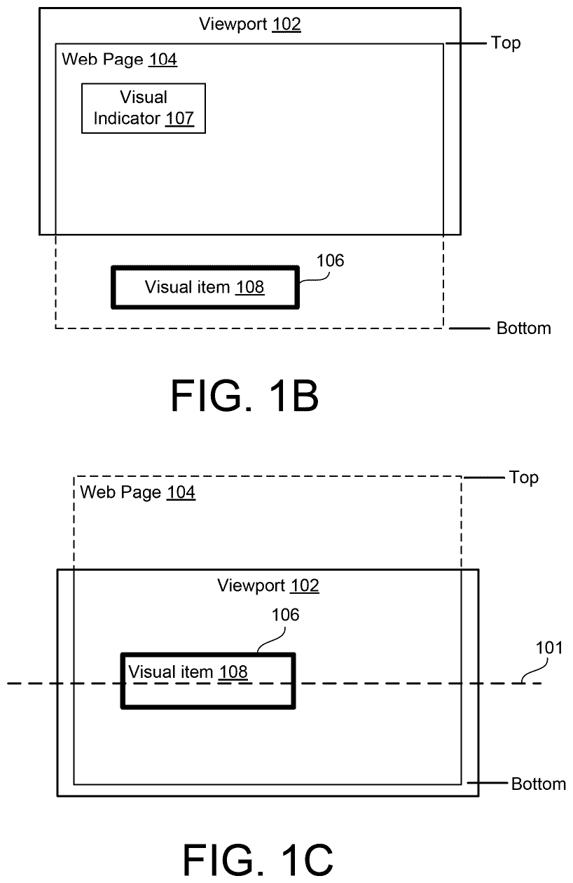

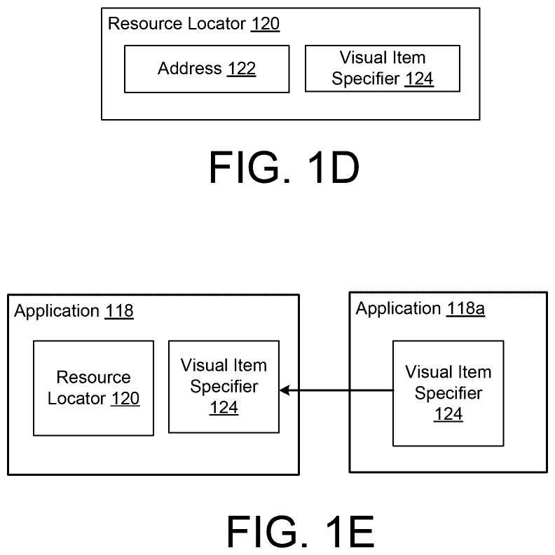

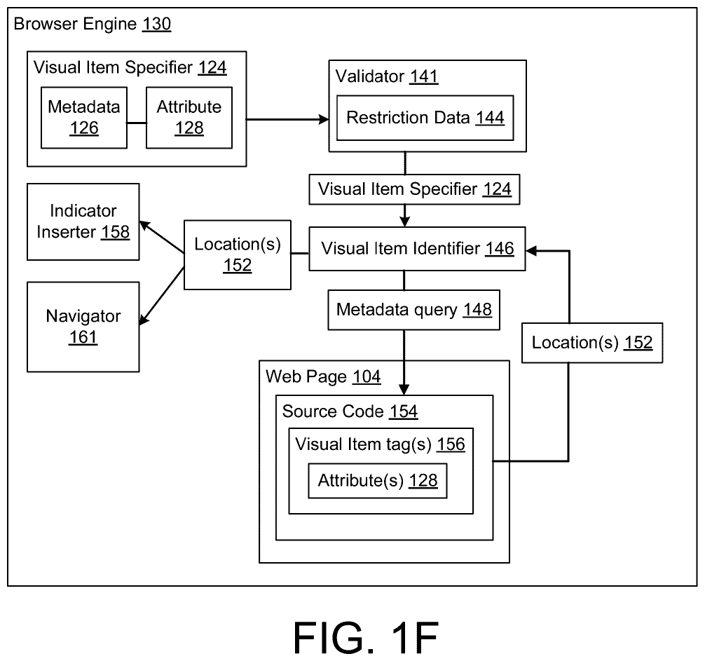

FIGS. 1A through 1F illustrate a system 100 for rendering a visual indicator 107 that indicates a presence and/or a location of a visual item 108 on a web page 104. The system 100 includes a computing device 110. The computing device 110 may be any type of computing device that includes one or more processors 112, one or more memory devices 114, a display 138, and an operating system 116 configured to execute (or assist with executing) one or more applications, including an application 118.

The application 118 includes or is associated with a browser engine 130. In some examples, the application 118 is a browser application. In some examples, the application 118 is a non-browser application that includes or is associated with a browser engine 130. In some examples, the browser engine 130 is a web view controller. The application 118 is configured to render a user interface 140 on the display 138. In some examples, the user interface 140 may include a window (e.g., a viewing section or panel) that displays the web page 104. In some examples, the user interface 140 includes one or more sections that do not include the window such as an address bar, a navigation scroll bar, a tool bar, etc.

Referring to FIG. 1B, the visual item 108 may not be in a viewport 102 when the browser engine 130 renders at least a portion of the web page 104 on the display 138 (e.g., in the window of the user interface 140 that displays the web page 104). The viewport 102 may represent the area in computer graphics being viewed by the user and may vary depending on the size of the display 138. In some examples, the size of the viewport 102 may be dependent on the size of the window of a user interface 140 that displays the web page 104. In some examples, the viewport 102 is the visible area of a web page 104 on the display 138. In some examples, a size (e.g., length and/or width) of the web page 104 is larger than the size of the viewport 102, where at least a portion of the web page 104 is not visible to the user. To view other portions of a web page 104, a user may use one or more controls provided by the application 118 (e.g., the user interface 140) to navigate (e.g., scroll) the web page 104.

When the web page 104 is initially loaded by the browser engine 130, a portion of the web page 104 that includes the visual item 108 may not be visible to the user (e.g., outside the viewport 102). As shown in FIG. 1B, the visual item 108 may be located towards the bottom of the web page 104. However, the browser engine 130 may render a visual indicator 107 on the display 138 (e.g., within the viewport 102) when at least a portion of the web page 104 is rendered, where the visual indicator 107 may assist the user in locating the visual item 108 on the web page 104.

The browser engine 130 may render the visual indicator 107 at a location within the viewport 102. In some examples, the browser engine 130 may render the visual indicator 107 in a section of the user interface 140 that is separate (e.g., apart, different) from the display of web content. In some examples, the browser engine 130 may render the visual indicator 107 at a location that at least partially overlaps with the display of web content. The browser engine 130 may render the visual indicator 107 at a location that is different or separate from the location of the visual item 108.

The visual indicator 107 may be a UI object or element that is rendered on the display 138. In some examples, the visual indicator 107 may include a graphical feature (e.g., an arrow portion) that points to the location of the visual item 108. In some examples, the visual indicator 107 may include a V-shaped portion. For example, the visual indicator 107 may include a graphical element portion that resembles an arrow that points in the direction of the location of the visual item 108. In some examples, the visual indicator 107 includes a representation of the visual item 108. The visual indicator 107 includes a thumbnail of the visual item 108. In some examples, the visual indicator 107 may include one or more navigation controls that, when selected, cause the browser engine 130 to scroll to one or more visual items 108. In some examples, the visual indicator 107 is a highlighted portion of a navigation control element (e.g., a scroll bar), where the navigation control element is configured to adjust a visual area (e.g., a viewpoint 102 of the web page 104) that is displayed on the display 138. In some examples, the visual indicator 107 is a highlighted portion of the scroll bar that indicates the location of the visual item 108 on the scroll bar. In some examples, the visual indicator 107 may include an animation that causes attention to the visual indicator 107. In some examples, the visual indicator 107 may move on the display 138 to bring the user's attention to the visual indicator.

The browser engine 130 may receive a selection to the visual indicator 107 and, in response to the selection to the visual indicator 107, as shown in FIG. 1C, the browser engine 130 may adjust a visual area of the web page 104 such that the visual item 108 is visible to a user. For example, the browser engine 130 may scroll (e.g., vertically and/or horizontally scroll) the web page 104 to position the visual item 108 in the viewport 102. In some examples, the action of scrolling may refer to the action of moving a web page 104 (e.g., moving vertically and/or horizontally) on a display 138 to view a different portion of the web page.

In some examples, the browser engine 130 may adjust the visual area of the web page 104 such that the visual item 108 is positioned at a predetermined location of the viewport 102. In some examples, the visual item 108 is positioned at a location that is a threshold distance away from an edge (e.g., bottom edge) of the viewport 102. In some examples, the browser engine 130 may vertically scroll the web page 104 to position the visual item 108 to a location that aligns to a central axis 101 of the viewport 102. The central axis 101 may divide the viewport 102 in equal halves, e.g., a top half and a top half. In some examples, at least a portion of the visual item 108 intersects with the central axis 101. In some examples, a central axis of the visual item 108 is aligned with the central axis 101. In some examples, the browser engine 130 may horizontally scroll the web page 104 to position the visual item in the viewport 102. In some examples, when the browser engine 130 detects that the visual item 108 is in the viewport 102, the browser engine 130 may perform an action (e.g., execute an animation) on the visual indicator 107 to inform the user that they were successful in getting to the visual item 108. In some examples, the visual indicator 107 may disappear from the display 138. In some examples, the visual indicator 107 may move (e.g., bounce).

In some examples, the browser engine 130 determines whether the visual item 108 is at least partially not visible to the user when the web page 104 is loaded, and, if so, the browser engine 130 renders the visual indicator 107. In some examples, the browser engine 130 determines whether the visual item 108 is visible to the user when the web page 104 is loaded, and, if so, the browser engine 130 does not render the visual indicator 107. In some examples, regardless of whether the visual item 108 is visible to the user, the browser engine 130 renders the visual indicator 107. In some examples, when the web page 104 is loaded, the visual item 108 is completely out of the viewport 102, and, in response to the selection to the visual indicator 107, the browser engine 130 may scroll the web page such that the visual item 108 is fully within the viewport 102. In some examples, when the web page 104 is loaded, the visual item 108 is partially out of the viewport 102, and, in response to the selection to the visual indicator 107, the browser engine 130 may scroll the web page 104 such that the visual item 108 is fully within the viewport 102.

In some examples, the visual indicator 107 is (or includes) an animation. In some examples, the animation is sound. In some examples, the visual indicator 107 is not visible but a sound effect (e.g., when the visual item 108 is in the viewport 102) or a combination of visual and sound effects. In some examples, the animation includes text animation. In some examples, the animation includes color animation. In some examples, the animation includes slide-in animation. In some examples, the animation includes rotate animation. In some examples, the animation includes bounce animation. In some examples, the animation includes fade-in animation.

In some examples, instead of click-to-navigate UI type of object, the user may manually scroll to the visual item 108, and the visual indicator 107 may be an animation (e.g., fade out as the user gets nearer, animate when they are getting closer, make a noise) to signify that the user is getting closer to the visual item 108.

In some examples, multiple visual indicators 107 are displayed on the display 138. In some examples, two or more visual indicators 107 may be displayed at the same time. In some examples, two or more visual indicators 107 may be displayed at different locations. In some examples, the visual indicators 107 are displayed at different times. In some examples, the visual indicators 107 include multiple UI elements, highlighted portions of a control element, animations, etc. In some examples, the visual indicator(s) 107 may change, appear, and/or disappear in response to navigation of the web page 104 (e.g., the user getting closer to the visual item 108). In some examples, multiple visual indicators 107 may be positioned at a number of positions in the scroll bar. Those visual indicators 107 pointing at scroll positions nearer to the viewport 102 may become larger and, as could animate (e.g., fade out) when the visual item 108 is actually within the viewport 102. In some examples, this would permit more visual indicators 107 pointing at the scroll bar while still making them clear to see when scrubbing.

In some examples, the browser engine 130 is configured to also highlight the visual item 108, e.g., add or adjust a border around the visual item 108, change the appearance of the visual item 108, etc. For example, the browser engine 130 may render a highlight indicator 106 that highlights the visual item 108. In some examples, the highlight indicator 106 may include one or more of the features that is explained with reference to the visual indicator 107. In some examples, the highlight indicator 106 is positioned on the visual item 108. In some examples, the highlight indicator 106 is positioned next to the visual item 108. In some examples, the highlight indicator 106 is positioned around the visual item 108. In some examples, the highlight indicator 106 is a display aspect of the visual item 108 that has been changed by the browser engine 130. For example, the size, color, and/or tint of at least a portion of the visual item 108 may be changed by the browser engine 130 to highlight the visual item 108. In some examples, the highlight indicator 106 is a border of the visual item 108 that has been enlarged. In some examples, the appearance (e.g., color, tint, etc.) of the border can be changed by the browser engine 130. In some examples, the highlight indicator 106 may be a graphical element that is inserted by the browser engine 130 to indicate the location of the visual item 108.

In some examples, the highlight indicator 106 may include an animation and/or sound effect. In some examples, the highlight indicator 106 may include blinking (e.g., quickly showing/hiding) the visual item 108 for a period of time (e.g., a second or two), animating size or position of the visual item 108 (e.g., make the visual item 108 shake or beat for a period of time), and/or animating other portion(s) of the web page 104 (e.g., fading and/or adjusting a shade (e.g., gray out) the rest of the web page 104 surroundings around the visual item 108. In some examples, the highlight indicator 106 may include a sound effect (e.g., causing a clicking noise when the mouse hovers over the visual item 108). In some examples, the visual item 108 may be modified such that it appears closer to the user and/or the visual item 108 may be modified to have additional depth. In some examples, these effects may be visible to the user when they are moving around the page. In some examples, the visual item 108 may be an item rendered in color (e.g., the only item rendered in color) causing the non-highlighted elements to fade or be displayed in black and white.

Referring to FIG. 1A, the browser engine 130 may receive a resource locator 120 that identifies a web page 104 to be rendered on the display 138. The resource locator 120 includes an address 122 of the web page 104 on a server computer 160, and the browser engine 130 uses the address 122 to retrieve the web page 104 over a network 150. The address 122 may be referred to as a web address. In some examples, the address 122 is a URL.

The browser engine 130 obtains a visual item specifier 124 associated with the web page 104, where the visual item specifier 124 identifies a visual item 108 that is included on the web page 104. In some examples, the visual item 108 is an image. In some examples, the visual item 108 is a video. In some examples, the visual item 108 is text. In some examples, the visual item specifier 124 can identify a single visual item 108 that is included on the web page 104. In some examples, the visual item specifier 124 can identify multiple visual items 108 that are included on the web page 104 (e.g., multiple instances of the same visual item 108). In some examples, if the visual item 108 does not appear on the web page 104 (e.g., the visual item 108 is not found on the web page 104), the browser engine 130 may render a UI object that indicates that the visual item 108 could not be located (e.g., because the web page 104 changed since the URL was created).

The visual item specifier 124 includes metadata 126 about an attribute 128 of the visual item 108. The metadata 126 may include one or more values (e.g., letters, numbers, symbols, etc.) that can identify a visual item 108. The attribute 128 may be any type of attribute (e.g., HTML attributes) that is used for images, videos, and/or text. The attribute 128 may relate to a location of the visual item 108, a characteristic of the visual item 108, text associated with the visual items, and/or a style (e.g., inline style) of the visual item 108. The metadata 126 includes value(s) that define the attribute 128. The metadata 126 may include at least a portion of a path or link (e.g., URL) of where the visual item 108 is stored. In some examples, the metadata 126 includes text related to the visual item 108.

In some examples, the visual item specifier 124 includes an element selector. In some examples, the visual item specifier 124 includes a cascading style sheets (CSS) selector. In some examples, the visual item specifier 124 includes a simple selector. In some examples, the visual item specifier 124 includes a compound selector. In some examples, the visual item specifier 124 is associated with a type such as an image selector that can select an image, a video selector that can select a video, or a text selector that can select text. In some examples, the visual item specifier 124 is associated with an identifier. In some examples, the attribute 128 is one of an alt attribute, a href attribute, a poster attribute, a scr attribute, a srcset attribute, and a style attribute. In some examples, the visual item specifier 124 is restricted to a subset of attributes 128 (e.g., alt, href, poster, scr, srcset). In some examples, the value key of the selector is the metadata 126.

Referring to FIG. 1D, in some examples, the visual item specifier 124 is included as part of the resource locator 120. For example, the resource locator 120 includes the address 122 of the web page 104 and the visual item specifier 124. The browser engine 130 may obtain the visual item specifier 124 from the resource locator 120 to obtain a location 152 of a visual item 108 as indicated by the visual item specifier 124.

Referring to FIG. 1E, in some examples, the visual item specifier 124 is separate from the resource locator 120. For example, the visual item specifier 124 may be information that is considered distinct from the resource locator 120. In some examples, the browser engine 130 obtains the visual item specifier 124 from the application 118. In some examples, the browser engine 130 obtains the visual item specifier 124 from an application 118a. The application 118a may be a program that is separate from the application 118. In some examples, the application 118 is a browser application, and the browser engine 130 obtains the visual item specifier 124 from the application 118 or a separate application, e.g., the application 118a. In some examples, the application 118 is a non-browser application, and the browser engine 130 obtains the visual item specifier 124 from the application 118 or a separate application, e.g., the application 118a.

The browser engine 130 may use the visual item specifier 124 to identify a location 152 of the visual item 108 on the web page 104. In some examples, in response to the browser engine 130 identifying a location 152 of the visual item 108 on the web page 104 using the visual item specifier 124, the browser engine 130 is configured to render the visual indicator 107, and, in some examples, render the highlight indicator 106 on the visual item 108. In some examples, the browser engine 130 is configured to scroll the web page 104 such that the visual item 108 is displayed when the web page 104 is loaded.

In some examples, the browser engine 130 is configured to generate the visual item specifier 124 or generate a resource locator 120 with the visual item specifier 124. For example, in response to selection of a control taken with respect to a particular visual item 108 on a web page 104, the browser engine 130 may generate the visual item specifier 124 and/or generate (or adjust) the resource locator 120 to include the visual item specifier 124. For example, the browser engine 130 may obtain information from an attribute 128 of a visual item tag 156 (e.g., an HTML video tag, an HTML image tag, etc.) corresponding to the visual item 108, where the information may be any type of information described with reference to the metadata 126. For example, the information may be a link (or a portion thereof) that points to a location of where the visual item 108 is stored, text information about the visual item 108, and/or style information about the visual item 108, etc. The browser engine 130 may use this information as the metadata 126 that is included in the visual item specifier 124.

A visual item specifier 124 is used to find or select a visual item 108 in a source code 154 of a web page 104. For example, the browser engine 130 may use the metadata 126 as a search query to search the source code 154 (e.g., visual item tags 156) to determine whether a visual item tag 156 matches (or corresponds to) the metadata 126 from the visual item specifier 124. Then, based on the matching visual item tag 156, the browser engine 130 can determine a location 152 of the visual item 108.

FIG. 1F illustrates a browser engine 130 according to an aspect. The browser engine 130 may receive a visual item specifier 124 relating to a visual item 108 included on a web page 104. The browser engine 130 may include a validator 141 configured to determine whether the visual item specifier 124 is valid based on the information included in the visual item specifier 124 and/or restriction data 144. In some examples, the validator 141 may restrict the rendering of the visual indicator 107 and/or scrolling to the visual item 108 based on the restriction data 144. In some examples, the restriction data 144 requires a user gesture or activation to have occurred. In some examples, the restriction data 144 requires the web page 104 to be in a top-level browsing context (e.g., no iframes). In some examples, the restriction data 144 requests cross-document navigation unless initiated by the user from the user interface 140.

The browser engine 130 includes a visual item identifier 146 configured to identify a location 152 of the visual item 108 on the web page 104 in response to the validator 141 validating the visual item specifier 124. For example, visual item identifier 146 may use the metadata 126 in a metadata query 148 to search the source code 154 of the web page 104 for a match. For example, the visual item identifier 146 may execute a metadata query 148 with the metadata 126 as the search criteria to search visual item tags 156 in the source code 154 of the web page 104. The visual item tags 156 may be image tags or video tags. The image tags or video tags may include attributes 128. If the metadata 126 of an attribute 128 matches information from the corresponding attribute 128 in the source code 154, the visual item specifier 124 selects the visual item 108 and determines a location 152 of the visual item 108 from the visual item tags 156 and/or the structure of the web page 104.

The browser engine 130 may include an indicator inserter 158 configured to render the visual indicator 107 and/or the highlight indicator 106, as explained above. For example, in response to the location 152 of the visual item 108, the indicator inserter 158 may render the visual indicator 107. In some examples, the indicator inserter 158 may render a highlight indicator 106 at the location 152 of the visual item 108. In some examples, the browser engine 130 includes a navigator 161 that can scroll to the visual item 108.

In some examples, the computing device 110 is a laptop computer. In some examples, the computing device 110 is a desktop computer. In some examples, the computing device 110 is a tablet computer. In some examples, the computing device 110 is a smartphone. In some examples, the computing device 110 is a wearable device. In some examples, the computing device 110 is or includes a virtual reality (VR) or augmented reality (AR) headset. In some examples, the display 138 is the display of the computing device 110. In some examples, the display 138 may also include one or more external monitors that are connected to the computing device 110.

The operating system 116 is a system software that manages computer hardware, software resources, and provides common services for computing programs. In some examples, the operating system 116 is an operating system designed for a larger display 138 such as a laptop or desktop (e.g., sometimes referred to as a desktop operating system). In some examples, the operating system 116 is an operating system for a smaller display 138 such as a tablet or a smartphone (e.g., sometimes referred to as a mobile operating system).

The processor(s) 112 may be formed in a substrate configured to execute one or more machine executable instructions or pieces of software, firmware, or a combination thereof. The processor(s) 112 can be semiconductor-based—that is, the processors can include semiconductor material that can perform digital logic. The memory device(s) 114 may include a main memory that stores information in a format that can be read and/or executed by the processor(s) 112. The memory device(s) 114 may include a non-transitory computer-readable medium that stores executable instructions that cause the processor(s) 112 to perform certain operations discussed herein. The memory device(s) 114 may store the operating system 116 and the application 118 that, when executed by the processors 112, perform certain operations discussed herein.

In some examples, the application 118 includes a browser application. In some examples, the application 118 includes a non-browser application. In some examples, the application 118 includes a native application. In some examples, the application 118 is a software program that is developed for use on a particular platform or device, or for a particular operating system. In some examples, the application 118 is installed on the operating system 116 of the computing device 110. In some examples, the application 118 is a native mobile application configured to execute on a mobile operating system of the computing device 110 such as a smartphone or a tablet. In some examples, the native mobile applications may include an Android application, a mobile iOS application, and/or a mobile Windows application. In some examples, the application 118 is an application configured to execute on a desktop operating system of the computing device 110 such as a laptop computer or a desktop computer. In some examples, the application 118 is a Linux-based application (e.g., a Linux application in a virtualized environment). In some examples, the application 118 is a software program that is developed for multiple platforms or devices. In some examples, the application 118 is a software program developed for use on a mobile platform and/or configured to execute on a desktop or laptop computer. In some examples, the application 118 is a server application executable by a server computer 160.

The server computer 160 may be computing devices that take the form of a number of different devices, for example a standard server, a group of such servers, or a rack server system. In some examples, the server computer(s) 160 may be a single system sharing components such as processors and memories. In some examples, the server computer(s) 160 may be multiple systems that do not share processors and memories. The network 150 may include the Internet and/or other types of data networks, such as a local area network (LAN), a wide area network (WAN), a cellular network, satellite network, or other types of data networks. The network 150 may also include any number of computing devices (e.g., computer, servers, routers, network switches, etc.) that are configured to receive and/or transmit data within network 150. Network 150 may further include any number of hardwired and/or wireless connections.

The server computer(s) 160 may include one or more processors formed in a substrate, an operating system (not shown) and one or more memory devices. The memory devices may represent any kind of (or multiple kinds of) memory (e.g., RAM, flash, cache, disk, tape, etc.). In some examples (not shown), the memory devices may include external storage, e.g., memory physically remote from but accessible by the server computer(s) 160. The server computer(s) 160 may include one or more modules or engines representing specially programmed software.

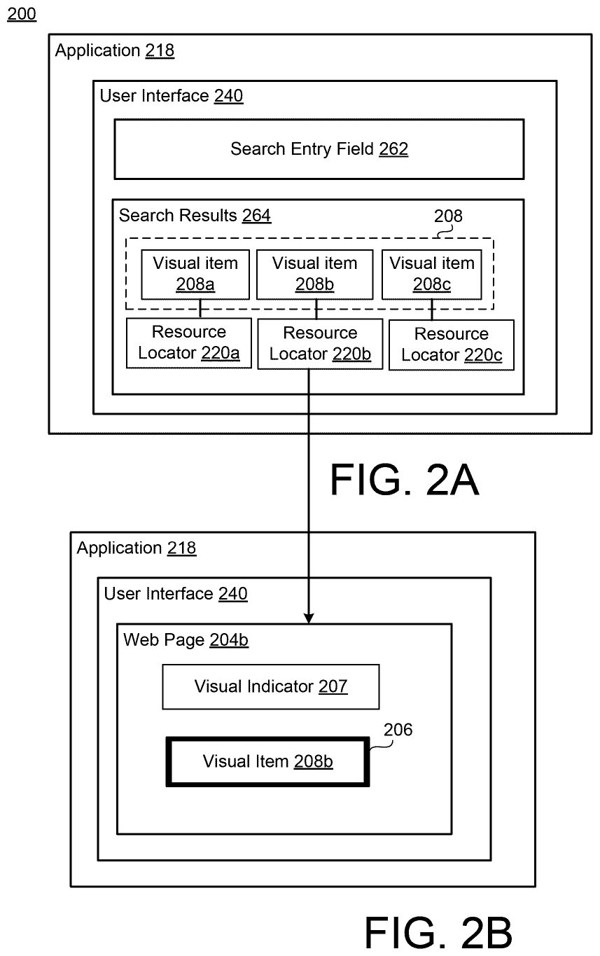

FIGS. 2A and 2B illustrate a system 200 for rendering a visual indicator 207 to indicate a visual item 208 on a web page 204b in response to a selection on search results 264 according to an aspect. The system 200 may be an example of the system 100 of FIGS. 1A through 1F and may include any of the details discussed with reference to those figures. As shown in FIG. 2A, an application 218 may provide a user interface 240. In some examples, the application 218 is a browser application. In some examples, the application 218 is a non-browser application. The user interface 240 includes a search entry field 262 for receiving a search query (e.g., one or more search terms) to search web content. In response to the search query, the user interface 240 displays a plurality of visual items 208 as the search results 264. In some examples, the plurality of visual items 208 are images that resulted from an image search. In some examples, the plurality of visual items 208 are videos that resulted from a video search. In some examples, the plurality of visual items 208 are text snippets that resulted from a text search.

The search results 264 may include a visual item 208a, a visual item 208b, and a visual item 208c. The visual item 208a is associated with a resource locator 220a for a web page that includes the visual item 208a. The visual item 208b is associated with a resource locator 220b for a web page 204b that includes the visual item 208b. The visual item 208c is associated with a resource locator 220c for a web page that includes the visual item 208c. In some examples, the search results 264 include the resource locator in association with the respective visual item 208. In some examples, in response to a particular visual item 208 being included in the search results 264, the application 218 may generate or modify the resource locator to include the visual item specifier (e.g., the visual item specifier 124 of FIGS. 1A through 1F).

In response to the selection of the visual item 208b or the resource locator 220b, a browser engine (e.g., the browser engine 130 of FIGS. 1A through 1F) may render at least a portion of the web page 204b in the user interface 240 of the application 218. Also, the browser engine may render a visual indicator 207 that indicates the location and/or presence of the visual item 208b on the web page 204b. In some examples, the resource locator 220b includes a visual item specifier (e.g., the visual item specifier 124 of FIGS. 1 through 1F). In some examples, in response to the selection of the visual item 208b, the application 218 may generate or modify the resource locator 220b to include the visual item specifier.

Also, a highlight indicator 206 is rendered on or close to the visual item 208b. In some examples, the highlight indicator 206 is positioned around the visual item 208b. In some examples, the highlight indicator 206 is a display aspect of the visual item 208b that has been changed by the browser engine. For example, the size, color, and/or tint of at least a portion of the visual item 208b may be changed by the browser engine to highlight the visual item 208b. In some examples, the highlight indicator 206 is a border of the visual item 208b that has been enlarged and/or highlighted in a different color (e.g., red).

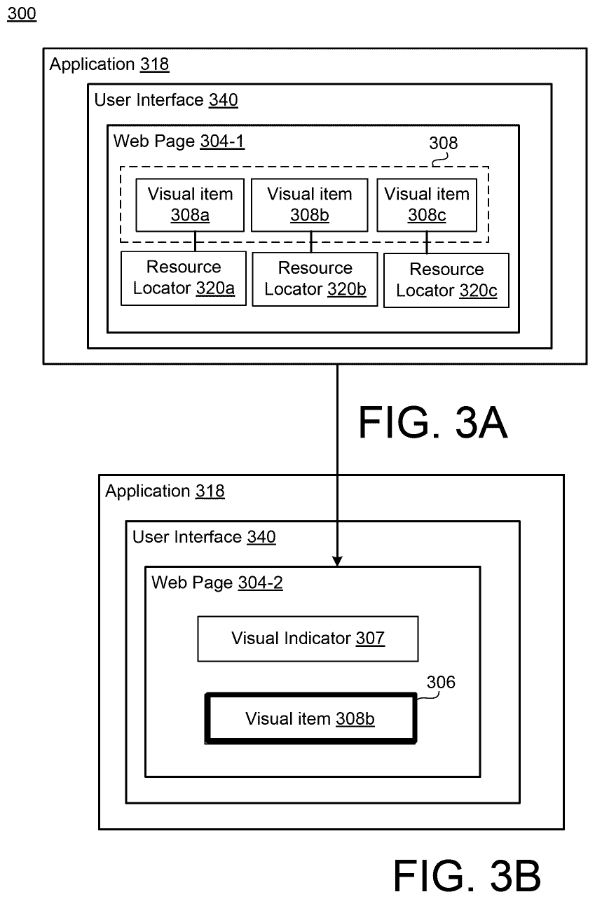

FIGS. 3A and 3B illustrate a system 300 for rendering a visual indicator 307 to indicate a visual item 308 on a web page 304-2 in response to a selection of a visual item 308b on a web page 304-1 according to an aspect. The system 300 may be an example of the system 100 of FIGS. 1A through 1F and may include any of the details discussed with reference to those figures. As shown in FIG. 3A, an application 318 may provide a user interface 340. In some examples, the application 318 is a browser application. In some examples, the application 318 is a non-browser application. The user interface 340 may display a web page 304-1 having one or more visual items 308. In the example of FIG. 3A, the web page 304-1 includes a visual item 308a, a visual item 308b, and a visual item 308c. In some examples, the plurality of visual items 308 are images. In some examples, the plurality of visual items 208 are videos. In some examples, the plurality of visual items 208 are text snippets.

The visual item 308a is associated with a resource locator 320a for a web page that includes the visual item 308a. The visual item 308b is associated with a resource locator 320b for a web page 304-2 that includes the visual item 308b. The visual item 308c is associated with a resource locator 320c for a web page that includes the visual item 308c.

In response to the selection of the visual item 308b or the resource locator 320b, a browser engine (e.g., the browser engine 130 of FIGS. 1A through 1F) may render at least a portion of the web page 304-2 in the user interface 340 of the application 318. Also, the browser engine may render a visual indicator 307 that indicates the location and/or presence of the visual item 308b on the web page 304-2. In some examples, the resource locator 320b includes a visual item specifier (e.g., the visual item specifier 124 of FIGS. 1 through 1F). In some examples, in response to the selection of the visual item 308b, the application 318 may generate or modify the resource locator 320b to include the visual item specifier.

Also, a highlight indicator 306 is rendered on or close to the visual item 308b. In some examples, the highlight indicator 306 is positioned around the visual item 308b. In some examples, the highlight indicator 306 is a display aspect of the visual item 308b that has been changed by the browser engine. For example, the size, color, and/or tint of at least a portion of the visual item 308b may be changed by the browser engine to highlight the visual item 308b. In some examples, the highlight indicator 306 is a border of the visual item 308b that has been enlarged and/or highlighted in a different color (e.g., red).

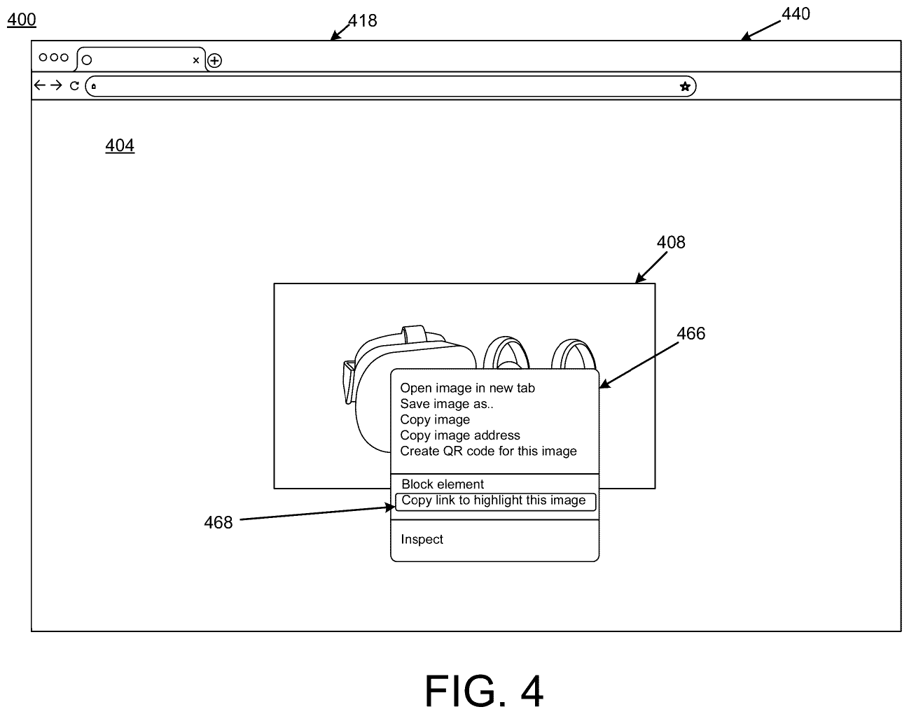

FIG. 4 illustrates a system 400 for generating a link to highlight a visual item 408 on a web page 404 according to an aspect. The system 400 may be an example of the system 100 of FIGS. 1A through 1F and may include any of the details discussed with reference to those figures. As shown in FIG. 4, an application 418 may provide a user interface 440. In some examples, the application 418 is a browser application. In some examples, the application 418 is a non-browser application. The user interface 440 may display a web page 404 having a visual item 408. In some examples, the application 418 may receive a selection to the visual item 408, which causes a UI object 466 to be rendered on the user interface 440. The UI object 466 may include one or more controls to execute certain actions with respect to the visual item 408, and one of the controls may include a control 468 to copy to highlight the visual item 408. When the control 468 is selected, the application 418 may generate a resource locator for the web page 404 that includes a visual item specifier (e.g., the visual item specifier 124 of FIGS. 1A through 1F). The user can place the resource locator in a browser tab or share the resource locator, and, when the browser engine receives the resource locator, the browser engine may render the web page and a visual indicator that indicates a presence and/or location of the image on the web page.

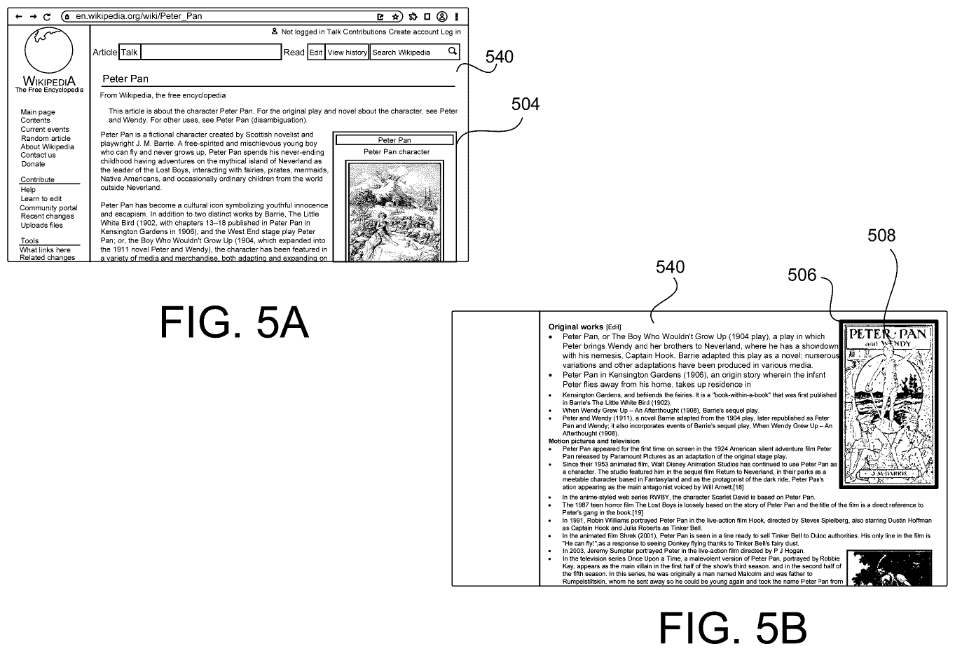

FIGS. 5A and 5B illustrates a user interface 540 includes a highlight indicator 506 that highlights a visual item 508 according to an aspect. The highlight indicator 506 may be an example of the highlight indicator 106 of FIGS. 1A through 1F and may include any of the details discussed with reference to those figures. In some examples, when a browser engine (e.g., the browser engine 130 of FIGS. 1A through 1F) receives a resource locator (e.g., the resource locator 120 of FIGS. 1A through 1F) and a visual item specifier (e.g., the visual item specifier 124 of FIGS. 1A through 1F), the browser engine may render with the user interface 540 with the highlight indicator 506. In some examples, the browser engine scrolls to the visual item 508 when the web page 504 is loaded.

The user interface 540 displays a portion of a web page 504 when the web page 504 is loaded. However, a portion of the web page 504 that includes the visual item 508 is not displayed when the web page 504 is loaded. In other words, the section of the user interface 540 that displays the web page 504 is smaller than the size of the web page 504 and this section may be referred to as the viewport. Referring to FIG. 5A, when the web page 504 is loaded, the user interface 540 displays a portion of a web page 504. In some examples, the user manually scrolls the web page 504 until the visual item 508 is visible, as shown in FIG. 5B. In some examples, when the web page 504 is loaded, the browser engine scrolls the web page 504 such that the visual item 508 is visible.

As shown in FIG. 5B, a highlight indicator 506 is provided on the visual item 508 to highlight the visual item 508. In some examples, the highlight indicator 506 is positioned on the visual item 508. In some examples, the highlight indicator 506 is positioned next to the visual item 508. In some examples, the highlight indicator 506 is positioned around the visual item 508. In some examples, the highlight indicator 506 is a display aspect of the visual item 508 that has been changed by the browser engine. For example, the size, color, and/or tint of at least a portion of the visual item 508 may be changed by the browser engine to highlight the visual item 508. In some examples, the highlight indicator 506 is a border of the visual item 508 that has been enlarged and/or changed to a different color (e.g., red). In some examples, the highlight indicator 106 may be a graphical element that is inserted by the browser engine 130 to indicate the location of the visual item 108.

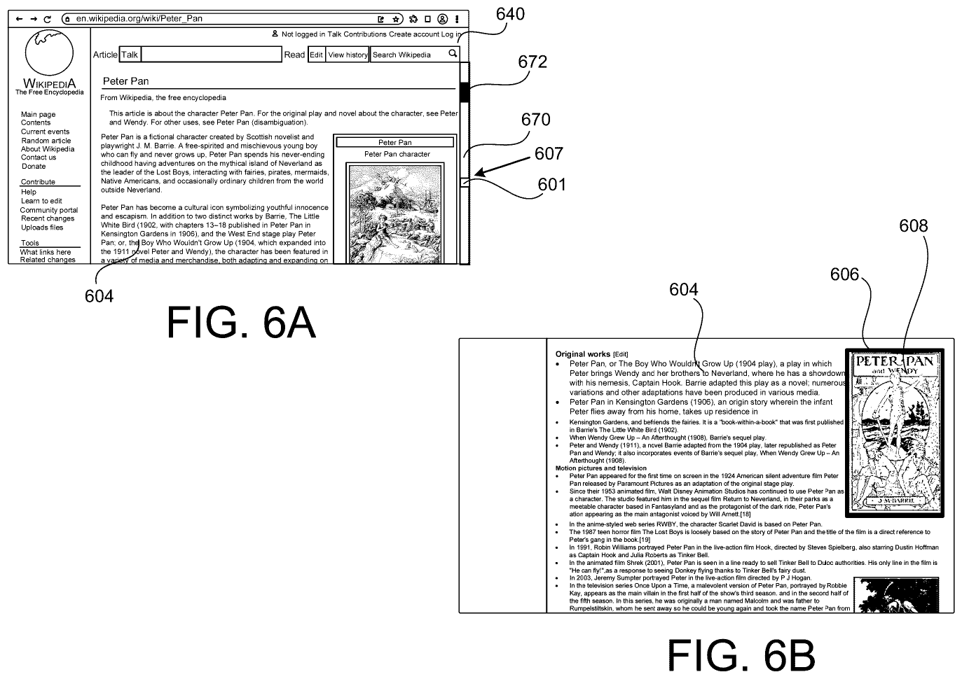

FIGS. 6A and 6B illustrate a user interface 640 includes a visual indicator 607 that indicates a presence and/or a location of a visual item 608 on a web page 604 and a highlight indicator 606 that highlights the visual item 608 according to an aspect. The visual indicator 607 may be an example of the visual indicator 107 of FIGS. 1A through 1F and may include any of the details discussed with reference to FIGS. 1A through 1F. The highlight indicator 606 may be an example of the highlight indicator 106 of FIGS. 1A through 1F and may include any of the details discussed with reference to FIGS. 1A through 1F.

In some examples, when a browser engine (e.g., the browser engine 130 of FIGS. 1A through 1F) receives a resource locator (e.g., the resource locator 120 of FIGS. 1A through 1F) and a visual item specifier (e.g., the visual item specifier 124 of FIGS. 1A through 1F), the browser engine may render with the user interface 640 with the visual indicator 607 and/or the highlight indicator 606. In some examples, instead of rendering the visual indicator 607, the browser engine scrolls to the visual item 608 when the web page 604 is loaded.

The user interface 640 displays a portion of a web page 604 when the web page 604 is loaded. However, a portion of the web page 604 that includes the visual item 608 is not displayed when the web page 604 is loaded. In other words, the section of the user interface 640 that displays the web page 604 is smaller than the size of the web page 604 and this section may be referred to as the viewport.

The user interface 640 includes a navigation control element 670 configured to adjust a visual area of the web page 604 that is displayed on a display of the computing device. A user may use the navigation control element 670 to adjust the visual area of the web page 604, e.g., which portion of the web page 604 is visible to the user. In some examples, the navigation control element 670 includes a vertical scroll bar that enables the user to scroll the web page 104 in a vertical direction (e.g., up or down). The navigation control element 670 includes an indicator 672 that indicates a current position of the web page 604, e.g., which portion of the web page 604 is visible to the user.

The visual indicator 607 includes a highlighted portion 601 of the navigation control element 670. In some examples, the highlighted portion 601 has a rectangle shape. In some examples, the highlighted portion 601 has a size (e.g., length/width) smaller than the size of the indicator 672. The highlighted portion 601 indicates the location of the visual item 608 on the web page 604. The highlighted portion 601 may be a portion of the navigation control element 670 that is changed, e.g., different color, or tint, etc. For example, the browser engine may change a display aspect of the navigation control element 670 to indicate the location of the visual item 608. In some examples, the highlighted portion 601 is selectable, which, when selected, causes the browser engine to navigate to the visual item 608, as shown in FIG. 6B.

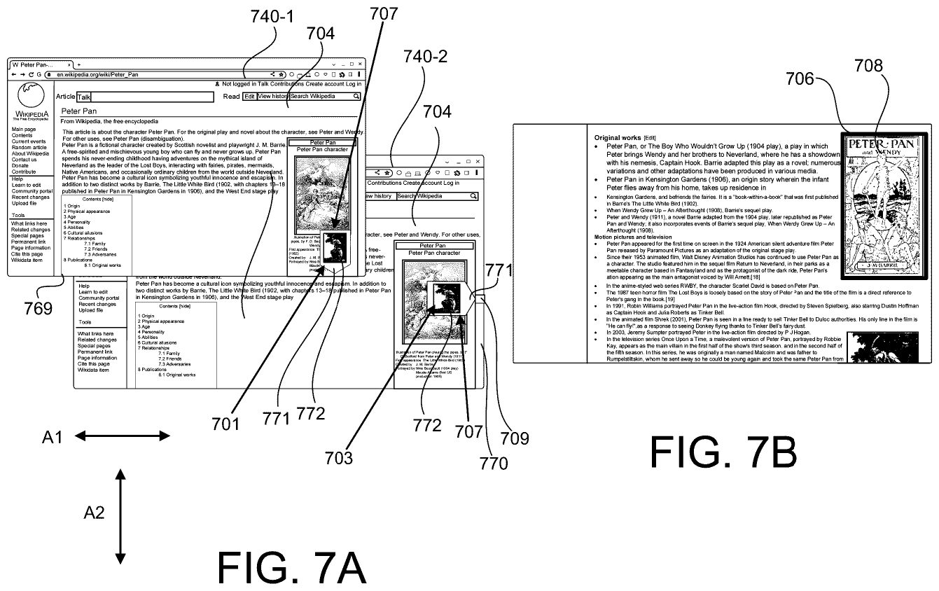

FIGS. 7A and 7B illustrate examples of a visual indicator 707 that indicates a presence and/or a location of a visual item 708 and a highlight indicator 706 that highlights the visual item 708 according to an aspect. Also, the visual indicator 707 may be used to quickly bring the visual item 708 into the viewport (e.g., by selecting the visual indicator 707). The visual indicator 707 may be an example of the visual indicator 107 of FIGS. 1A through 1F and may include any of the details discussed with reference to FIGS. 1A through 1F. The highlight indicator 706 may be an example of the highlight indicator 106 of FIGS. 1A through 1F and may include any of the details discussed with reference to FIGS. 1A through. If.

In some examples, when a browser engine (e.g., the browser engine 130 of FIGS. 1A through 1F) receives a resource locator (e.g., the resource locator 120 of FIGS. 1A through 1F) and a visual item specifier (e.g., the visual item specifier 124 of FIGS. 1A through 1F), the browser engine may render a user interface 740-1 or a user interface 740-2 with the visual indicator 707 and/or the highlight indicator 706. In some examples, instead of rendering the visual indicator 707, the browser engine scrolls to the visual item 708 when the web page 704 is loaded.

Referring to FIG. 7A, the user interface 740-1 displays a portion of a web page 704 when the web page 704 is loaded. However, a portion of the web page 704 that includes the visual item 708 is not displayed when the web page 704 is loaded. In other words, the section of the user interface 740-1 that displays the web page 704 is smaller than the size of the web page 704 and this section may be referred to as the viewport.

The user interface 740-1 includes a visual indicator 707 that indicates a location of the visual item 708. The visual indicator 707 of the user interface 740-1 includes a UI object 701. The UI object 701 may be rendered when the web page 704 is initially loaded. In some examples, the UI object 701 includes a representation 772 of the visual item 708. In some examples, the representation 772 is a thumbnail image. In some examples, the representation 772 is a thumbnail image of a frame of a video. In some examples, the UI object 701 includes an arrow portion 771 that points in the direction of the location of the visual item 708.

The UI object 701 may be positioned along (or within a threshold distance) of an edge 769 of the user interface 740-1. In some examples, the edge 769 is a bottom edge of the user interface 740-1. In some examples, the edge 769 is a top edge of the user interface 740-1. A direction A1 is aligned with the edge 769. A direction A2 is perpendicular to the direction A1. The direction A1 may be considered a horizontal direction and the direction A2 may be considered a virtual direction. In some examples, the arrow portion 771 contacts (or is within a threshold distance) of the edge 769. The location of the UI object 701 along the direction A1 may be dependent upon the location of visual item 708 along the direction A1. In other words, the UI object 701 may be positioned at other locations along the direction A1, which depends on the location of the visual item 708. For example, the UI object 701 may be positioned at a location along the direction A1 such that the visual item 708 and the UI object are aligned in the direction A2. In some examples, the arrow portion 771 points along a line that intersects with a central axis of the visual item 708 in the direction A2.

In some examples, the UI object 701 is selectable. The UI object 701, when selected, may cause the web page 704 to move in the direction A2 such that the visual item 708 is displayed (e.g., visible to the user), as shown in FIG. 7B. In some examples, the web page 704 is vertically scrolled such that the visual item 708 is positioned towards the top of the viewport. In some examples, the UI object 701 is not selectable, where the user may manually scroll to the visual item 708.

As shown in FIG. 7B, a highlight indicator 106 is rendered on or close to the visual item 708. In some examples, as shown in FIG. 7B, the highlight indicator 706 is positioned around the visual item 708. In some examples, the highlight indicator 706 is a display aspect of the visual item 708 that has been changed by the browser engine. For example, the size, color, and/or tint of at least a portion of the visual item 708 may be changed by the browser engine to highlight the visual item 708.

Referring back to FIG. 7A, the user interface 740-2 displays a portion of a web page 704 when the web page 704 is loaded. However, a portion of the web page 704 that includes the visual item 708 is not displayed when the web page 704 is loaded. In other words, the section of the user interface 740-2 that displays the web page 704 is smaller than the size of the web page 704 and this section may be referred to as the viewport.

The user interface 740-2 includes a visual indicator 707. The visual indicator 707 of the user interface 740-2 includes a UI object 703. The UI object 703 may be rendered when the web page 704 is initially loaded. In some examples, the UI object 703 includes a representation 772 of the visual item 708. In some examples, the representation 772 is a thumbnail image. In some examples, the representation 772 is a thumbnail image of a frame of a video. In some examples, the UI object 703 is similar to the UI object 701 except the UI object 703 may indicate a location of the visual item 708 by indicating a location (e.g., a highlighted portion 709) on a navigation control element 770.

The navigation control element 770 is configured to adjust a visual area of the web page 704 that is displayed on a display of the computing device. A user may use the navigation control element 770 to adjust the visual area of the web page 704, e.g., which portion of the web page 704 is visible to the user. In some examples, the navigation control element 770 includes a vertical scroll bar that enables the user to scroll the web page 704 in a vertical direction (e.g., up or down). The highlighted portion 709 is a section of the navigation control element 770 that indicates a location of the visual item 708. The UI object 703 may be rendered at a location that contacts or is within a threshold distance of the highlighted portion 709. In some examples, the UI object 703 includes an arrow portion 771 that points to the highlighted portion 709. In some examples, the arrow portion 771 contacts an edge of the highlighted portion 709. The location of the UI object 703 along the direction A2 may be dependent upon the location of the highlighted portion 709.

In some examples, the UI object 703 is selectable. The UI object 703, when selected, may cause the web page 704 to move in the direction A2 such that the visual item 708 is displayed (e.g., visible to the user), as shown in FIG. 7B. In some examples, the web page 704 is vertically scrolled such that the visual item 708 is positioned towards the top of the viewport. In some examples, the UI object 703 is not selectable, where the user may manually scroll to the visual item 708.

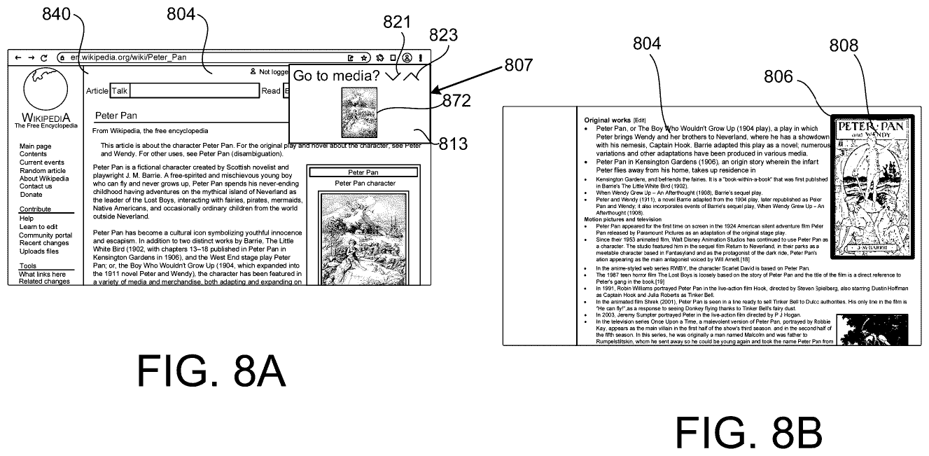

FIGS. 8A and 8B illustrate examples of a visual indicator 807 that indicates a presence and/or a location of a visual item 808 and a highlight indicator 806 that highlights the visual item 808 according to an aspect. The visual indicator 807 may be an example of the visual indicator 107 of FIGS. 1A through 1F and may include any of the details discussed with reference to FIGS. 1A through 1F. The highlight indicator 806 may be an example of the highlight indicator 106 of FIGS. 1A through 1F and may include any of the details discussed with reference to FIGS. 1A through 1F.

In some examples, when a browser engine (e.g., the browser engine 130 of FIGS. 1A through 1F) receives a resource locator (e.g., the resource locator 120 of FIGS. 1A through 1F) and a visual item specifier (e.g., the visual item specifier 124 of FIGS. 1A through 1F), the browser engine may render a user interface 840 with the visual indicator 807 and/or the highlight indicator 806. In some examples, instead of rendering the visual indicator 807, the browser engine scrolls to the visual item 808 when the web page 804 is loaded.

The user interface 840 displays a portion of a web page 804 when the web page 804 is loaded. However, a portion of the web page 804 that includes the visual item 808 is not displayed when the web page 804 is loaded. In other words, the section of the user interface 840 that displays the web page 804 is smaller than the size of the web page 804 and this section may be referred to as the viewport.

The user interface 840 includes a visual indicator 807 that indicates a location of the visual item 808. The visual indicator 807 includes a UI object 813. The UI object 813 may be rendered when the web page 804 is initially loaded. In some examples, the UI object 813 includes a representation 872 of the visual item 808. In some examples, the representation 872 is a thumbnail image. In some examples, the representation 872 is a thumbnail image of a frame of a video. In some examples, the UI object 813 has a rectangular shape.

The UI object 813 may include one or more navigation control elements, e.g., a navigation control element 821 and a navigation control element 823. The navigation control elements may enable the user to automatically scroll to portions of the web page 804 that include one or more visual items 808. For example, if there are multiple visual items 808 that are the same, the user may use the navigation control elements on the UI object 813 to display a portion of the web page 804 that includes the visual item 808. For example, the navigation control element 821, when selected, causes a browser engine to navigate the web page 804 to the next visual item 808, and the navigation control element 821, when selected, causes the browser engine to navigate the web page 804 to the previous visual item 808. In some examples, the navigation control element 821 is considered a forward navigation control element that selects the next visual item on the web page 804 and the navigation control element 821 is considered a back navigation control element that selects the previous visual item on the web page 804.

In some examples, the UI object 813 is rendered in a predetermined location on the user interface 840. In some examples, the UI object 813 is overlaid on the web content of the web page 804 in a corner portion of the viewport. In some examples, if the UI object 813 at least partially overlaps with the visual item 808, the UI object 813 is moved to a different portion of the user interface 840.

When the navigation control element 821 is selected, the web page 804 is moved in a vertical direction such that the visual item 808 is displayed (e.g., visible to the user), as shown in FIG. 8B. In some examples, when the portion of the web page 804 is shown in the user interface 840, the UI object 813 is still displayed on the user interface 840. If the navigation control element 821 is selected again, the web page 804 is moved such that the next visual item 808 is displayed (e.g., visible to the user). If the navigation control element 823 is selected, the web page 804 is moved such that the previous visual item 808 is displayed (e.g., visible to the user).

As shown in FIG. 8B, a highlight indicator 806 is rendered on or close to the visual item 808. In some examples, as shown in FIG. 8B, the highlight indicator 806 is positioned around the visual item 808. In some examples, the highlight indicator 806 is a display aspect of the visual item 808 that has been changed by the browser engine. For example, the size, color, and/or tint of at least a portion of the visual item 808 may be changed by the browser engine to highlight the visual item 808.

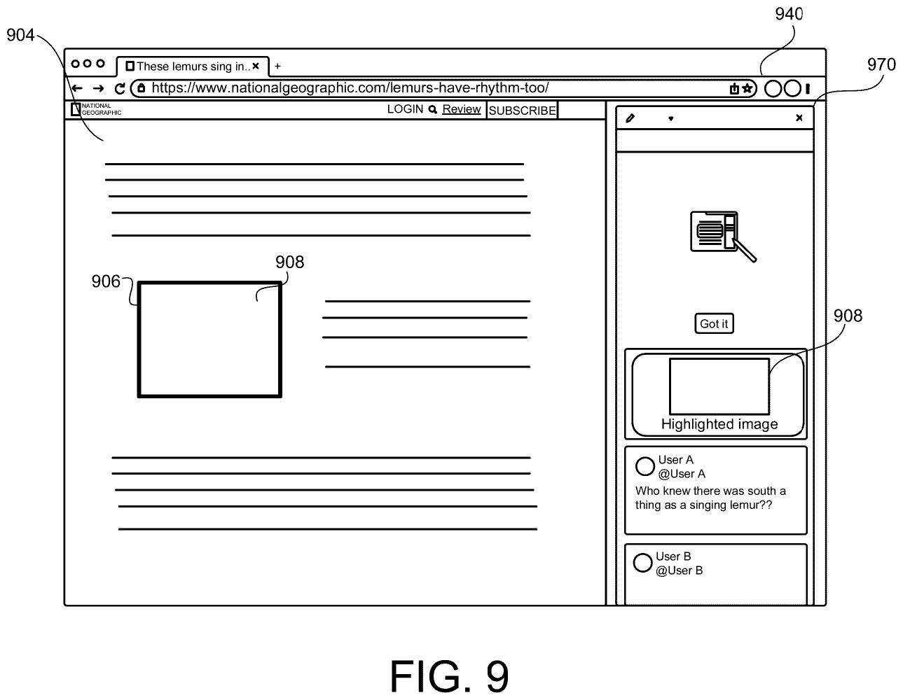

FIG. 9 illustrates an example of a user interface 940 that highlights a visual item 908 in an annotation section 970 of the user interface 940. In some examples, when a browser engine (e.g., the browser engine 130 of FIGS. 1A through 1F) receives a resource locator (e.g., the resource locator 120 of FIGS. 1A through 1F) and a visual item specifier (e.g., the visual item specifier 124 of FIGS. 1A through 1F), the browser engine may render a user interface 940 with an instance of the visual item 908 being displayed in the annotation section 970 of the user interface 940. For example, the visual item 908 is displayed as an annotation in the annotation section 970. In some examples, the annotation section 970 is a UI section that allows the user to create, display, and share notes about the web page 904.

In some examples, the receipt of the visual item specifier may cause the user interface 940 to display the annotation section 970 with the visual item 908. In some examples, the annotation section 970 is not initially displayed, but the user can view the visual item 908 in the annotation section 970 when the user opens the annotation section 970 (e.g., from a menu or control on the user interface 940). In some examples, the visual item 908 in the annotation section 970 is selectable. When selected, the browser engine scrolls the web page 904 to the portion of the web page 904 that includes the visual item 908.

A highlight indicator 906 is rendered on or close to the visual item 808. In some examples, as shown in FIG. 9, the highlight indicator 906 is positioned around the visual item 908. In some examples, the highlight indicator 906 is a display aspect of the visual item 908 that has been changed by the browser engine. For example, the size, color, and/or tint of at least a portion of the visual item 908 may be changed by the browser engine to highlight the visual item 908. In some examples, the highlight indicator 906 is a border of the visual item 908 that has been enlarged and/or highlighted in a different color (e.g., red).

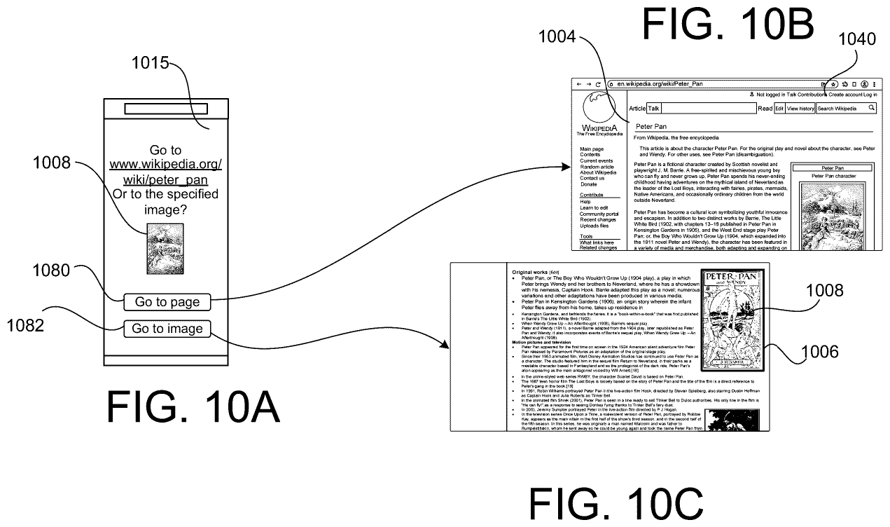

FIG. 10A illustrates an example of an interstitial web page 1015 that is displayed before a web page 1004 is displayed according to an aspect. When a resource locator corresponding to the web page 1004 and a visual item specifier that identifies a visual item 1008 are received by a browser engine, an interstitial web page 1015 is rendered before the web page 1004 is rendered. In some examples, the receipt of the visual item specifier may cause the browser engine to display the interstitial web page 1015. The interstitial web page 1015 may allow the user to select between loading the web page 1004 without the browser engine scrolling to the visual item 1008 or loading the web page 1004 with the browser engine scrolling to the visual item 1008.

The interstitial web page 1015 may include a control 1080. The control 1080, when selected, causes the browser engine to display the web page 1004 in a user interface 1040, as shown in FIG. 10B. If a selection to the control 1080 is received, the web page 1004 is loaded without scrolling the web page 1004 to the visual item 1008. The interstitial web page 1015 may include a control 1082. The control 1082, when selected, causes the browser engine to load the web page 1004 in a user interface 1040 and scroll the web page 1004 such that the visual item 1008 is displayed, as shown in FIG. 10C.

Also, a highlight indicator 1006 is rendered on or close to the visual item 1008. In some examples, as shown in FIG. 10C, the highlight indicator 1006 is positioned around the visual item 1008. In some examples, the highlight indicator 1006 is a display aspect of the visual item 1008 that has been changed by the browser engine. For example, the size, color, and/or tint of at least a portion of the visual item 1008 may be changed by the browser engine to highlight the visual item 1008. In some examples, the highlight indicator 1006 is a border of the visual item 1008 that has been enlarged and/or highlighted in a different color (e.g., red).

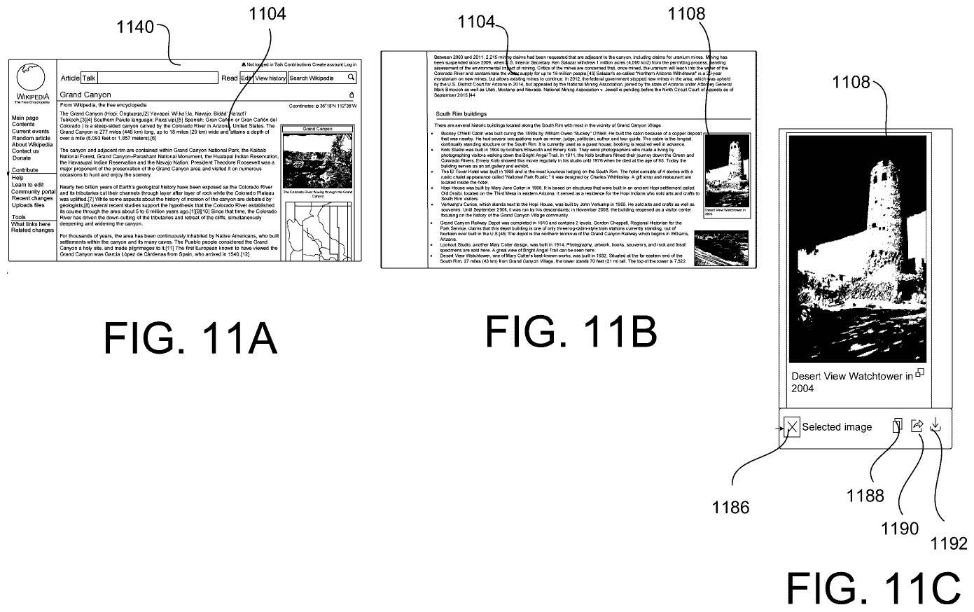

FIG. 11A through 11C illustrates an example using a visual item 1108 as a self-indicator according to an aspect. When a browser engine receives a resource locator corresponding to a web page 1104 and a visual item specifier that identifies a visual item 1108, the browser engine may load the web page 1104 in a user interface 1140, as shown in FIG. 11A. In the example of FIG. 11A, the browser engine does not scroll the web page 1104. Rather, the user may manually scroll the web page 1104. As the user scrolls to where the visual item 1108 is located on the web page 1104, the browser engine may fade the content behind the visual item 1108 such that the visual item 1108 is brought into focus, as shown in FIG. 11C.

The browser engine may detect that the visual item 1108 is displayed on the display, which causes the browser engine to execute an animation effect (e.g., a stylistic effect) on the content of the web page 1104. The browser engine may cause web content (other than the visual item 1108) to fade (e.g., gradually fade) over a period of time (e.g., becoming less bright). This animation effect may cause the visual item 1108 to be highlighted.

FIG. 11C illustrates an enlarged view of the visual item 1108 on the web page 1104 of FIG. 11C. In some examples, the browser engine may render one or more action controls to allow the user to take quick actions, such as copy the address, share, and download the visual item 1108. For example, the user interface 1140 may include a control 1186 that allows the user to deselect the visual item 1108, which causes the animation effect to be removed. The user interface 1140 may include an action control 1188. The action control, when selected, causes the resource locator of the web page 1104 to be selected. The user interface 1140 may include an action control 1190. The action control 1190, when selected, causes the visual item 1108 to be shared. The user interface 1140 may include an action control 1192. The action control 1192, when selected, causes the visual item 1108 to be downloaded.

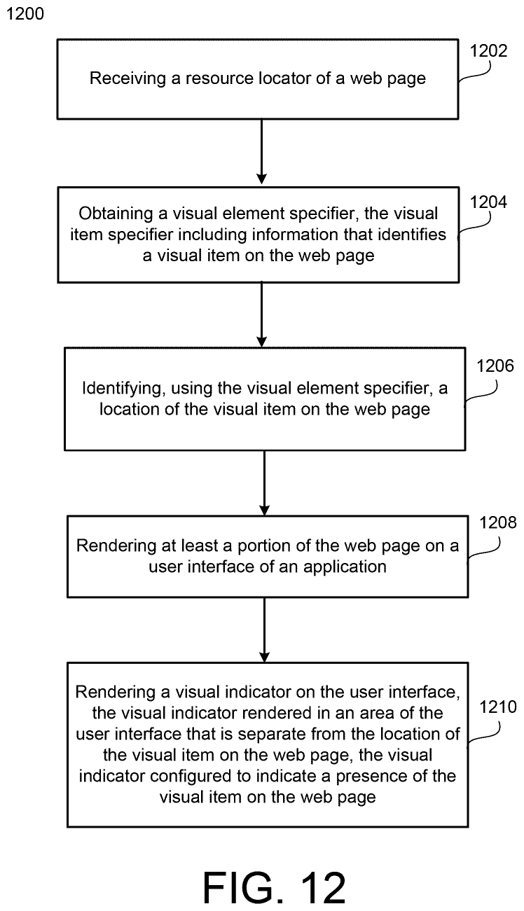

FIG. 12 is a flowchart 1200 depicting example operations of rendering a visual indicator on a user interface to indicate a presence and/or location of a visual item on the web page according to an aspect. The visual item may be an image or a video. In some examples, the visual item may be text. In some examples, the operations are executed by a browser engine. The browser engine may be part of a browser application. In some examples, the browser engine may be part of a non-browser application. A user may be interested in viewing a particular visual item on the web page. For example, a user may select a particular visual item from search results or the user may select a particular visual item from a website that has a collection of visual items. In some examples, a user may select a particular visual item on a web page to generate a link (e.g., a resource locator) that can also identify the visual item and the user can share that link with other users.

When the web page is loaded, the visual item may not be visible and the user may have to navigate (e.g., scroll) the web page to locate the visual item on the web page. For example, the visual item may be located towards the bottom of the web page, therefore, when the web page is loaded, the visual item may be outside an application's viewport. Furthermore, an application may not have the ability and/or provide a user control for searching for images and/or videos on a loaded web page. However, the operations of the flowchart 1200, a technical solution is provided for rendering a visual indicator to assist the user in locating a visual item on the web page.

Although the flowchart 1200 is explained with respect to the system 100 of FIGS. 1A through 1F, the flowchart 1200 may be applicable to any of the implementations discussed herein. Although the flowchart 1200 of FIG. 12 illustrates the operations in sequential order, it will be appreciated that this is merely an example, and that additional or alternative operations may be included. Further, operations of FIG. 12 and related operations may be executed in a different order than that shown, or in a parallel or overlapping fashion.

Operation 1202 includes receiving a resource locator 120 of a web page 104. For example, a browser engine 130 may receive the resource locator 120 when a user selects a particular link or item or enters the resource locator 120 in an address bar.

Operation 1204 includes obtaining a visual element specifier 124, the visual item specifier 124 including information that identifies a visual item 108 on the web page 104. In some examples, the visual item specifier 124 includes metadata 126 about an attribute of the visual item 108. In some examples, the resource locator 120 includes the visual element specifier 124, and the browser engine 130 obtains the visual item specifier 124 from the resource locator 120. In some examples, the visual element specifier 124 is separate from the resource locator 120. Operation 1206 includes identifying, using the visual element specifier 124, a location 152 of the visual item 108 on the web page 104. In some examples, the browser engine 130 may use the metadata 126 in a metadata query 148 to search for a responsive visual item tag 156. In response to locating a visual item tag that meets the search criteria of the metadata query 148, the browser engine 130 may obtain the location 152 of the visual item 108 from the visual item tags 156 and/or the structure of the web page 104.

Operation 1208 includes rendering at least a portion of the web page 104 on a user interface 140 of an application 118. For example, the browser engine 130 loads the web page 104, where a portion of the web page 104 is displayed, e.g., visible to the user. In some examples, at least a portion of the visual item 108 is not visible to the user, e.g., outside the viewport 102. Operation 1210 includes rendering a visual indicator 107 on the user interface 140. The visual indicator 107 being rendered in an area of the user interface 140 that is separate (e.g., different) from the location 152 of the visual item 108 on the web page 104. The visual indicator 107 is configured to indicate a presence of the visual item 108 on the web page 104.

In some examples, the visual indicator 107 includes a UI object. In some examples, the visual indicator 107 is a highlighted portion of a navigation control element configured to adjust a visual area of the web page that is displayed on a display of the computing device. In some examples, the visual indicator 107 includes a graphical feature that points to the location of the visual item 108. In some examples, the visual indicator 107 includes a first navigation control and a second navigation control. In some examples, the first navigation control is a forward navigation control that, when selected, causes the web page to scroll to the next visual indicator 107. In some examples, the second navigation control is a back navigation control that, when selected, causes the web page 104 to scroll to the previous visual item 108. In some examples, the visual indicator 107 includes a representation of the visual item 108 (e.g., a thumbnail of an image). In some examples, the visual indicator 107 is selectable, and, when selected, causes the visual area of the web page 104 to be adjusted such that the visual item 108 is visible to the user.

In some examples, the operations include rendering a portion of the web page 104 that includes the visual item 108 and rendering a highlight indicator 106 that indicates the location 152 of the visual item 108. Rendering the highlight indicator 106 may include changing a display aspect of the visual item 108 and/or inserting a graphical element on the user interface. In some examples, the operations include rendering an interstitial web page before the web page 104 is rendered. The interstitial web page may include a first control that, when selected, causes the web page 104 to be loaded without scrolling. The interstitial web page may include a second control that, when selected, causes the web page 104 to be loaded with scrolling that scrolls to the visual item 108.

In some aspects, the techniques described herein relate to a method, wherein the portion of the web page is a first portion, the method further including: receiving a selection to the visual indicator; and rendering, in response to the selection to the visual indicator, a second portion of the web page that includes the visual item. In some aspects, the techniques described herein relate to a method, wherein the portion of the web page is a first portion, the method further including: rendering a second portion of the web page that includes the visual item; and rendering a highlight indicator that highlights the visual item. In some aspects, the techniques described herein relate to a method, wherein rendering the highlight indicator includes: inserting a graphical element on the user interface. In some aspects, the techniques described herein relate to a method, wherein rendering the highlight indicator includes: changing a display aspect of the visual item or the web page. In some aspects, the techniques described herein relate to a method, wherein the visual indicator is a highlighted portion of a navigation control element configured to adjust a viewport of the web page. In some aspects, the techniques described herein relate to a method, wherein the visual indicator includes a portion that points to the location of the visual item. In some aspects, the techniques described herein relate to a method, wherein the visual indicator includes a thumbnail of the visual item. In some aspects, the techniques described herein relate to a method, further including: rendering an interstitial web page before the web page is rendered, the interstitial web page including a first control that, when selected, causes the web page to be loaded without scrolling to the visual item, the interstitial web page including a second control that, when selected, causes the web page to be loaded with scrolling to the visual item. In some aspects, the techniques described herein relate to a method, further including: rendering, in response to a query, a plurality of visual items; receiving a selection of the visual item from the plurality of visual items; and receiving, in response to the selection of the visual item, the resource locator of the web page and the visual item specifier. In some aspects, the techniques described herein relate to a method, further including: receiving a selection of the visual item; and generating the resource locator to include the visual item specifier.

In some aspects, the techniques described herein relate to an apparatus, wherein the portion of the web page is a first portion, wherein the executable instructions include instructions that cause the at least one processor to: receive a selection to the visual indicator; and render, in response to the selection to the visual indicator, a second portion of the web page that includes the visual item. In some aspects, the techniques described herein relate to an apparatus, wherein the portion of the web page is a first portion, wherein the executable instructions include instructions that cause the at least one processor to: render a second portion of the web page that includes the visual item; and render a highlight indicator that highlights the visual item. In some aspects, the techniques described herein relate to an apparatus, wherein the visual indicator is a highlighted portion of a navigation control element configured to adjust a viewport of the web page. In some aspects, the techniques described herein relate to an apparatus, wherein the executable instructions include instructions that cause the at least one processor to: receive a query for accessing content; render, in response the query, a plurality of visual items; receive a selection of the visual item from the plurality of visual items; and receive, in response to the selection of the visual item, the resource locator of the web page and the visual item specifier.

In some aspects, the techniques described herein relate to a non-transitory computer-readable medium, wherein the portion of the web page is a first portion, the operations further including: receiving a selection to the visual indicator; and rendering, in response to the selection to the visual indicator, a second portion of the web page that includes the visual item.

In some aspects, the techniques described herein relate to a non-transitory computer-readable medium, wherein the portion of the web page is a first portion, the operations further including: rendering a second portion of the web page that includes the visual item; and rendering a highlight indicator that highlights the visual item. In some aspects, the techniques described herein relate to a non-transitory computer-readable medium, wherein the operations further include: receiving a selection of the visual item; and generating the resource locator to include the visual item specifier.

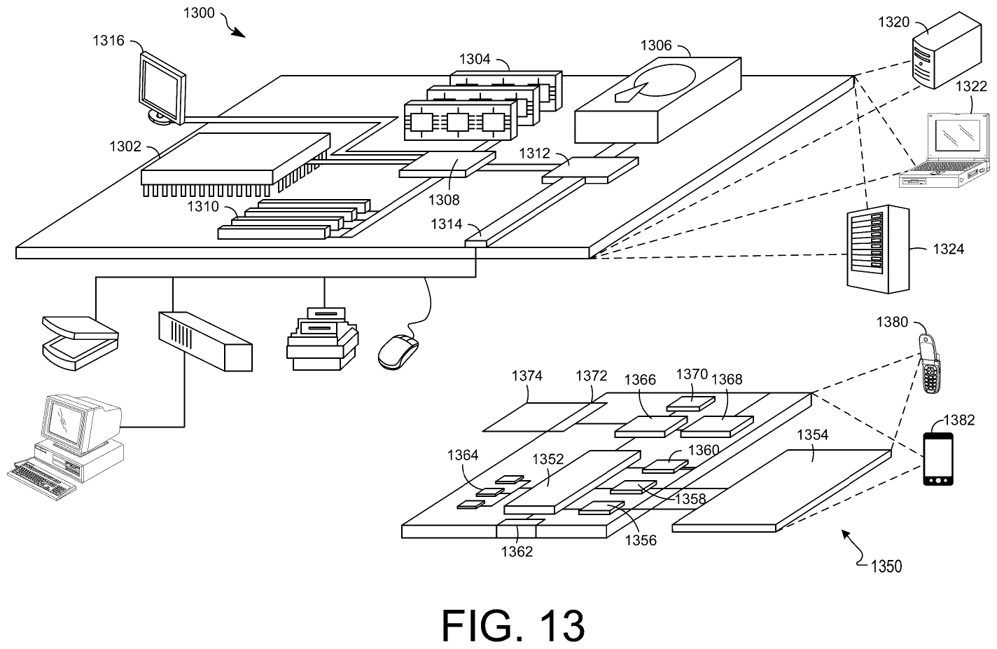

FIG. 13 shows an example of a computing device 1300 and a mobile computing device 1350, which may be used with the techniques described here. In some implementations, the computing device 1300 and the mobile computing device 1350 may be examples of any of the computing devices discussed with reference to the previous figures. Computing device 1300 is intended to represent various forms of digital computers, such as laptops, desktops, tablets, workstations, personal digital assistants, televisions, servers, blade servers, mainframes, and other appropriate computing devices. Computing device 1350 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 1300 includes a processor 1302, memory 1304, a storage device 1306, a high-speed interface 1308 connecting to memory 1304 and high-speed expansion ports 1310, and a low speed interface 1312 connecting to low speed bus 1314 and storage device 1306. The processor 1302 can be a semiconductor-based processor. The memory 1304 can be a semiconductor-based memory. Each of the components 1302, 1304, 1306, 1308, 1310, and 1312, are interconnected using various busses, and may be mounted on a common motherboard or in other manners as appropriate. The processor 1302 can process instructions for execution within the computing device 1300, including instructions stored in the memory 1304 or on the storage device 1306 to display graphical information for a GUI on an external input/output device, such as display 1316 coupled to high speed interface 1308. In other implementations, multiple processors and/or multiple buses may be used, as appropriate, along with multiple memories and types of memory. Also, multiple computing devices 1300 may be connected, with each device providing portions of the necessary operations (e.g., as a server bank, a group of blade servers, or a multi-processor system).

The memory 1304 stores information within the computing device 1300. In one implementation, the memory 1304 is a volatile memory unit or units. In another implementation, the memory 1304 is a non-volatile memory unit or units. The memory 1304 may also be another form of computer-readable medium, such as a magnetic or optical disk.

The storage device 1306 is capable of providing mass storage for the computing device 1300. In one implementation, the storage device 1306 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1304, the storage device 1306, or memory on processor 1302.

The high speed controller 1308 manages bandwidth-intensive operations for the computing device 1300, while the low speed controller 1312 manages lower bandwidth-intensive operations. Such allocation of functions are examples only. In one implementation, the high-speed controller 1308 is coupled to memory 1304, display 1316 (e.g., through a graphics processor or accelerator), and to high-speed expansion ports 1310, which may accept various expansion cards (not shown). In the implementation, low-speed controller 1312 is coupled to storage device 1306 and low-speed expansion port 1314. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1300 may be implemented in a number of different forms, as shown in the figure. For example, it may be implemented as a standard server 1320, or multiple times in a group of such servers. It may also be implemented as part of a rack server system 1324. In addition, it may be implemented in a personal computer such as a laptop computer 1322. Alternatively, components from computing device 1300 may be combined with other components in a mobile device (not shown), such as device 1350. Each of such devices may contain one or more computing devices 1300, 1350, and an entire system may be made up of multiple computing devices 1300, 1350 communicating with each other.

Computing device 1350 includes a processor 1352, memory 1364, an input/output device such as a display 1354, a communication interface 1366, and a transceiver 1368, among other components. The device 1350 may also be provided with a storage device, such as a microdrive or other device, to provide additional storage. Each of the components 1350, 1352, 1364, 1354, 1366, and 1368, are interconnected using various buses, and several of the components may be mounted on a common motherboard or in other manners as appropriate.

The processor 1352 can execute instructions within the computing device 1350, including instructions stored in the memory 1364. The processor may be implemented as a chipset of chips that include separate and multiple analog and digital processors. The processor may provide, for example, for coordination of the other components of the device 1350, such as control of user interfaces, applications run by device 1350, and wireless communication by device 1350.

Processor 1352 may communicate with a user through control interface 1358 and display interface 1356 coupled to a display 1354. The display 1354 may be, for example, a TFT LCD (Thin-Film-Transistor Liquid Crystal Display) or an OLED (Organic Light Emitting Diode) display, or other appropriate display technology. The display interface 1356 may comprise appropriate circuitry for driving the display 1354 to present graphical and other information to a user. The control interface 1358 may receive commands from a user and convert them for submission to the processor 1352. In addition, an external interface 1362 may be provided in communication with processor 1352, so as to enable near area communication of device 1350 with other devices. External interface 1362 may provide, for example, for wired communication in some implementations, or for wireless communication in other implementations, and multiple interfaces may also be used.

The memory 1364 stores information within the computing device 1350. The memory 1364 can be implemented as one or more of a computer-readable medium (e.g., a non-transitory computer-readable medium) or media, a volatile memory unit or units, or a non-volatile memory unit or units. Expansion memory 1374 may also be provided and connected to device 1350 through expansion interface 1372, which may include, for example, a SIMM (Single In Line Memory Module) card interface. Such expansion memory 1374 may provide extra storage space for device 1350 or may also store applications or other information for device 1350. Specifically, expansion memory 1374 may include instructions to carry out or supplement the processes described above and may include secure information also. Thus, for example, expansion memory 1374 may be provided as a security module for device 1350 and may be programmed with instructions that permit secure use of device 1350. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1364, expansion memory 1374, or memory on processor 1352 that may be received, for example, over transceiver 1368 or external interface 1362.

Device 1350 may communicate wirelessly through communication interface 1366, which may include digital signal processing circuitry where necessary. Communication interface 1366 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1368. In addition, short-range communication may occur, such as using a Bluetooth, Wi-Fi, or other such transceiver (not shown). In addition, GPS (Global Positioning System) receiver module 1370 may provide additional navigation- and location-related wireless data to device 1350, which may be used as appropriate by applications running on device 1350.

Device 1350 may also communicate audibly using audio codec 1360, which may receive spoken information from a user and convert it to usable digital information. Audio codec 1360 may likewise generate audible sound for a user, such as through a speaker, e.g., in a handset of device 1350. Such sound may include sound from voice telephone calls, may include recorded sound (e.g., voice messages, music files, etc.) and may also include sound generated by applications operating on device 1350.

The computing device 1350 may be implemented in a number of different forms, as shown in the figure. For example, it may be implemented as a cellular device 1380. It may also be implemented as part of a smartphone 1382, personal digital assistant, or another similar mobile device.

Further to the descriptions above, a user may be provided with controls allowing the user to make an election as to both if and when systems, programs or features described herein may enable collection of user information (e.g., information about a user's social network, social actions or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In this specification and the appended claims, the singular forms “a,” “an” and “the” do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections or logical connections may be present in a practical device. Moreover, no item or component is essential to the practice of the implementations disclosed herein unless the element is specifically described as “essential” or “critical”.

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, use of terms such as up, down, top, bottom, side, end, front, back, etc. herein are used with reference to a currently considered or illustrated orientation. If they are considered with respect to another orientation, it should be understood that such terms must be correspondingly modified.

Further, in this specification and the appended claims, the singular forms “a,” “an” and “the” do not exclude the plural reference unless the context clearly dictates otherwise. Moreover, conjunctions such as “and,” “or,” and “and/or” are inclusive unless the context clearly dictates otherwise. For example, “A and/or B” includes A alone, B alone, and A with B.

Although certain example methods, apparatuses and articles of manufacture have been described herein, the scope of coverage of this patent is not limited thereto. It is to be understood that terminology employed herein is for the purpose of describing particular aspects and is not intended to be limiting. On the contrary, this patent covers all methods, apparatus and articles of manufacture fairly falling within the scope of the claims of this patent.

1. A method comprising:
generating a modified resource locator of a web page by combining a web location of the web page and a visual item specifier, the visual item specifier including information about a visual item in the web page;
detecting the modified resource locator in an address field of a browser tab;
obtaining the visual item specifier from the modified resource locator;
identifying, using the visual item specifier, a location of the visual item on the web page;
rendering at least a portion of the web page on a user interface of the browser tab; and
rendering a visual indicator on the user interface, the visual indicator rendered in an area of the user interface that is different from the location of the visual item on the web page, the visual indicator configured to indicate a presence of the visual item on the web page.

2. The method of claim 1, wherein the portion of the web page is a first portion, the method further comprising:
receiving a selection to the visual indicator; and
rendering, in response to the selection to the visual indicator, a second portion of the web page that includes the visual item.

3. The method of claim 1, wherein the portion of the web page is a first portion, the method further comprising:
rendering a second portion of the web page that includes the visual item; and
rendering a highlight indicator that highlights the visual item.

4. The method of claim 3, wherein rendering the highlight indicator includes:
inserting a graphical element on the user interface.

5. The method of claim 3, wherein rendering the highlight indicator includes:
increasing a size of a border of the visual item or the web page.

6. The method of claim 1, wherein the visual indicator is a highlighted portion of a navigation scroll bar.

7. The method of claim 1, wherein the visual indicator includes a portion that points to the location of the visual item.

8. The method of claim 1, wherein the visual indicator includes a thumbnail of the visual item.

9. The method of claim 1, further comprising:
rendering an interstitial web page before the web page is rendered, the interstitial web page including a first control that, when selected, causes the web page to be loaded without scrolling to the visual item, the interstitial web page including a second control that, when selected, causes the web page to be loaded with scrolling to the visual item.

10. (canceled)

11. The method of claim 1, wherein the visual item specifier is a cascading style sheet (CSS) selector directive.

12. An apparatus comprising:
at least one processor; and
a non-transitory computer-readable medium including executable instructions that causes the at least one processor to:
generate a modified resource locator of a web page by combining a web location of the web page and a visual item specifier, the visual item specifier including information about a visual item in the web page;
detect the modified resource locator in an address field of a browser tab;
obtain the visual item specifier from the modified resource locator;
identify, using the visual item specifier, a location of the visual item on the web page;
render at least a portion of the web page on a user interface of the browser tab; and
render a visual indicator on the user interface, the visual indicator rendered in an area of the user interface that is different from the location of the visual item on the web page, the visual indicator configured to indicate a presence of the visual item on the web page.

13. The apparatus of claim 12, wherein the portion of the web page is a first portion, wherein the executable instructions include instructions that cause the at least one processor to:
receive a selection to the visual indicator; and
render, in response to the selection to the visual indicator, a second portion of the web page that includes the visual item.

14. The apparatus of claim 12, wherein the portion of the web page is a first portion, wherein the executable instructions include instructions that cause the at least one processor to:
render a second portion of the web page that includes the visual item; and
render a highlight indicator that highlights the visual item, the highlight indicator being an increased border of the visual item.

15. The apparatus of claim 12, wherein the visual indicator is a highlighted portion of a navigation scroll bar.

16. (canceled)

17. A non-transitory computer-readable medium storing executable instructions that cause at least one processor to execute operations, the operations comprising:
detecting a selection to a visual item on a web page displayed in a first browser tab;
generating a modified resource locator of the web page by combining a web location of the web page and a visual item specifier, the visual item specifier including information about the visual item in the web page;
detecting the modified resource locator in an address field of a second browser tab;
obtaining a visual item specifier from the modified resource locator;
identifying, using the visual item specifier, a location of the visual item on the web page;
rendering at least a portion of the web page on a user interface of the second browser tab; and
rendering a visual indicator on the user interface, the visual indicator rendered in an area of the user interface that is different from the location of the visual item on the web page, the visual indicator configured to indicate a presence of the visual item on the web page.

18. The non-transitory computer-readable medium of claim 17, wherein the portion of the web page is a first portion, the operations further comprising:
receiving a selection to the visual indicator; and
rendering, in response to the selection to the visual indicator, a second portion of the web page that includes the visual item.

19. The non-transitory computer-readable medium of claim 17, wherein the portion of the web page is a first portion, the operations further comprising:
rendering a second portion of the web page that includes the visual item; and
rendering a highlight indicator that highlights the visual item.

20. The non-transitory computer-readable medium of claim 17, wherein the visual item specifier is a cascading style sheet (CSS) selector directive.

21. The method of claim 1, wherein the browser tab is a second browser tab, the method further comprising:
detecting a selection to the visual item in a first browser tab; and
in response to the selection to the visual item being detected, generating the modified resource locator of the web page.

22. The apparatus of claim 12, wherein the browser tab is a second browser tab, wherein the executable instructions include instructions that cause the at least one processor to:
detect a selection to the visual item in a first browser tab; and
in response to the selection to the visual item being detected, generate the modified resource locator of the web page.
